(19) United States
(12) Patent Application Publication
(10) Pub. No.: US 2010/0225090 A1
(43) Pub. Date: Sep. 9, 2010

(54) AERODYNAMIC BICYCLE STRUCTURE

(76) Inventors: Douglas A. Cusack, Cottage Grove, WI (US); Paul Harder, Delafield, WI (US)

Correspondence Address: BOYLE FREDRICKSON S.C., 840 North Plankinton Avenue, MILWAUKEE, WI, 53203, US

(21) Appl. No.: 12/399,667

(22) Filed: Mar. 6, 2009

(51) Int. Cl. B62K 3/02

(52) U.S. Cl. 280/281.1

(57) ABSTRACT

A bicycle structure having a truncated airfoil cross-sectional shape oriented in a direction generally transverse to a longitudinal direction of the bicycle structure. The truncated shape has a generally rounded head, a pair of opposing sidewalls that extend from edges of the rounded head, and a blunt rear facing end wall. The blunt rear facing wall is maintained in a spaced relation so that a tail portion of overall airfoil shape is formed by air associated with the flow of air over the truncated airfoil cross-sectional shape.

### BACKGROUND OF THE INVENTION

The present invention relates generally to bicycles and, more particularly, to bicycle structures having a cross sectional shape that enhances the aerodynamic performance of the bicycle structure.

Traditionally, bicycle structures such as frames, seat tubes, fork blades, shift levers, etc. have generally circular or otherwise generally uniform smooth curvilinear cross-sectional shapes. Such structures have cross sections with relatively low length-to-width aspect ratios. As used herein, the aspect ratio of a cross section is defined as the unit length over the unit width wherein the length is oriented to be generally aligned with a direction of travel of the bicycle structure. For example, a bicycle structure having a cross section with a circular shape has an aspect ratio of approximately 1. During cycling, bicycle structures having aspect ratios of approximately 1 experience airflow detachment about a portion of the perimeter of the cross section of the bicycle structure. The airflow detachment creates a swirling and often turbulent region of air flow in a wake region generally immediately behind the respective bicycle tube. The wake in the air flow is indicative of energy dissipation and relatively high levels of drag associated with the bicycle structures and therefore the bicycle. Accordingly, such shapes present drawbacks that must be overcome by the rider.

In an effort to improve the aerodynamic performance and reduce the drag associated with operation of the bicycle, bicycle structures having improved aerodynamic characteristics have been constructed. One such widely accepted solution has been to provide the bicycle structure in an airfoil shape. Airfoils have been employed in a number of different applications including airplane wings and automobile spoilers as well as in the marine arts. When applied in the marine arts, such shapes are commonly referred to as hydrofoils or hydrofins.

Regardless of the specific application of the airfoil shaped structure, the cross sections of airfoils generally have lengths that are several times greater than their widths. A forward facing portion of the airfoil, or the leading edge, is generally curved, although other shapes are possible, and configured to be oriented in a forward facing direction relative to an intended direction of travel. Oppositely facing side walls extend rearward from the leading edge and converge at a trailing edge of the cross section of the airfoil.

The trailing edge forms the termination of the airfoil and is generally adjacent a narrowed, pointed tail section of the airfoil. A chord that extends between the leading edge and trailing edge of the cross section is indicative of the airfoil length and is generally many times longer than the longest chord extending between the oppositely facing side walls of the cross section. Chords that extend between the adjacent sidewalls of the airfoil are indicative of the width of the airfoil. Providing an air foil having a length that is greater than the width yields an airfoil having a cross section with an aspect ratio that is generally many times larger than a value of 1. The higher aspect ratio allows the airflow directed over the airfoil to conform to the shape of the airfoil and reduces the potential that the airflow will detach from the walls of the bicycle structures as compared to bicycle structures that have lower aspect ratios or ratios nearer to 1. Detached airflow is commonly understood to increase the drag of the airfoil through the fluid. The increased aspect ratio also reduces the size of the turbulent wake region that generally forms immediately behind the bicycle structure. Such phenomena have led many to conclude that improved aerodynamic performance can be achieved with airfoil shapes having aspect ratios much greater than one. Even though such airfoil shapes provide reduced drag performance as compared to structures having lower aspect ratios, such shapes are not without their respective drawbacks.

International bicycle racing regulations limit the permissible cross-sections for bicycle frame tubes. These regulations define a maximum length and a minimum width of the shape of the cross section and thereby effectively define a maximum allowable aspect ratio. For many experienced riders, this maximum allowable aspect ratio is less than ideal for reducing the amount of drag experienced by a rider. That is, such rider's can achieve performance conditions where greater performance benefits would be achieved at aspect ratios beyond the regulated limits. Thus, while airfoil shaped bicycle structures experience lower levels of drag as compared to traditional blunt cross-sections, e.g., circular, the regulated airfoil shaped tubes cannot realize the aerodynamic improvements possible with airfoils having higher aspect ratios.

In addition to the performance considerations discusses above, practical considerations also limit the attainable aspect ratios of bicycle structures. Understandably, as the length of the cross section increases and the width of the cross section decreases, although the aspect ratio increases, the strength and/or lateral stiffness of the bicycle structure decreases. Said in another way, the elongated shape of the cross section detracts from the lateral strength of the bicycle frame. Other's attempts to resolve this relationship have yielded frame assemblies with improved lateral strength performance but include weight increases that nearly offset the benefits achieved with the improved aerodynamic performance. Accordingly, attention must be given to the structural integrity and the weight of the bicycle frame when altering the shape of the cross section to achieve a desired aspect ratio.

Another shortcoming of many known airfoil constructions is the difficulty associated with forming the tapered tail section of the airfoil shape. The tail of a common airfoil shaped structure is relatively narrow and gradually transitions to the generally pointed trailing edge of the airfoil. Forming a blemish free pointed tail section is fairly difficult to manufacture and can be particularly problematic in the composite molding processes that are commonly utilized for manufacturing bicycle structures such as frames, frame tubes, fork tubes, and the like. Simply, it is difficult to maintain the desired shape of the frame tube sections with the materials and processes common to present day bicycle frame construction.

Therefore, there is a need for a bicycle structure having improved aerodynamic performance and which does not overly detract from the overall strength of the bicycle structure. Preferably, any such improvement is also in compliance with international bicycle racing regulations. Particularly, there is a need for bicycle structures that experience reduced drag during use and which are robust enough to withstand the rigors associated with aggressive riding. Further, there is a need for a bicycle structure with improved aerodynamic characteristics that is strong, stiff and has improved manufacturability.

### BRIEF DESCRIPTION OF THE INVENTION

The present invention provides an aerodynamic bicycle structure that overcomes one or more of the drawbacks discussed above. One aspect of the invention discloses a bicycle structure having a body that is defined by an exterior wall. The exterior wall of the body is oriented to have a cross-sectional shape that resembles a forward portion of an airfoil shape. The cross-sectional shape is defined by a head portion, a pair of opposing sidewalls that extend rearward from generally opposite ends of the head portion, and an end wall that is offset from the head portion. The end wall extends in a crossing direction relative to each sidewall so as to join rearward directed ends of each of the pair of opposing sidewalls. Said another way, the cross-sectional shape is defined by a traditional airfoil shape with the tail abruptly truncated. The body is typically attached to a bicycle so as to maintain an open space rearward of the body such that a flexible tail portion of the airfoil shape is formed by air that occupies the open space rearward of the end wall. The open space is occupied by a region of recirculating or stagnant fluid which behaves as a virtual or flexible tail, replacing the conventional tail surface of the airfoil shape.

Another aspect of the invention discloses a bicycle having a seat that is supported on a frame and configured to support a rider. The bicycle includes a pair of wheels that are rotatably attached to the frame. The bicycle includes a bicycle structure that has a partially airfoil shaped cross-section that has a forward facing head portion, a pair of opposing sidewalls that extend rearward relative to the head portion, and a rear wall opposite the head portion. The bicycle structure is maintained at an offset distance relative to adjacent structures of the bicycle. The offset distance is sufficient to allow air that travels over the bicycle structure to form a virtual airfoil tail rearward of the end wall of the truncated airfoil.

Another aspect of the invention discloses a method for providing an aerodynamic bicycle structure. The method includes providing a body that has a truncated airfoil shaped cross-section. A rear facing side of the body is maintained in a spaced relation relative to adjacent structures such that air directed over the body forms a virtual airfoil tail that tapers from the rear facing side of the body to a trailing edge as air flows around the bicycle structure.

Each of the aspects above disclose a bicycle structure that is aerodynamic and stronger and/or stiffer than bicycle structures formed of similar materials and having a cross-section that forms an entire air foil shape with comparable aspect ratios. Each of the aspects above provides a bicycle structure having improved drag performance as compared to traditional airfoils of the same aspect ratio. Preferably, the bicycle structures according to one or more of the above aspects may provide one or more of a tube of a bicycle frame, a fork blade, a wheel, a tire, a handlebar, a handlebar stem, a seat post, a stem, a pedal crank arm, a dropout, a shift lever and a cable of a bicycle assembly.

In a preferred aspect, the airfoil-shaped bicycle structure before truncation of the tail has a length-to-width aspect ratio of between about 3:1 and about 9:1. More preferably, the airfoil shape before truncation has an aspect ratio of approximately 5:1. More preferably still, the airfoil shape before truncation has an aspect ratio that is divergent from a 1:1 ratio and is configured to complement the orientation of the bicycle structure with respect to the direction of airflow.

Another aspect of the invention combinable with one or more of the aspects above includes providing a bicycle accessory, such as a water bottle or accessory container whose shape completes the airfoil shape or more preferably, mimics and/or cooperates with the shape of the bicycle structure so as to maintain a generally blunt termination of the accessory to allow air to form a virtual tail thereof.

It is appreciated that the aspects and features of the invention summarized above are not limited to any one particular embodiment of the invention. That is, many or all of the aspects above may be achieved with any particular embodiment of the invention. Those skilled in the art will appreciate that the invention may be embodied in a manner preferential to one aspect or group of aspects and advantages as taught herein. These and various other aspects, features, and advantages of the present invention will be made apparent from the following detailed description and the drawings.

### BRIEF DESCRIPTION OF THE DRAWINGS

The drawings illustrate preferred embodiments presently contemplated for carrying out the invention.

FIG. 1 is an elevation view of a bicycle having a number of bicycle structures according to the present invention;

FIG. 2 is an isometric view of a portion of a fork of the bicycle shown in FIG. 1;

FIG. 3 is a cross-sectional view of the fork shown in FIG. 2 and taken along line 3-3 shown in FIG. 1;

FIG. 4 is a cross-sectional view of a seat tube of the bicycle taken along line 4-4 shown in FIG. 1;

FIG. 5 is a view similar to FIGS. 3 and 4 and shows a standard air foil shaped structure in phantom and overlaying a bicycle structure according to the present invention;

FIG. 6 is a view similar to FIGS. 3 and 4 and shows a variety of positions of a virtual airfoil tail section that forms rearward of the bicycle structure as air travels over the body;

FIG. 7 is a diagram of a bicycle structure according to the present invention experiencing an airflow and shows a recirculation zone and development of a virtual airfoil tail that propagates rearward of the bicycle structure;

FIG. 8 is a cross-sectional view of a bicycle structure according to the present invention having sloped sidewalls;

FIG. 9 is a cross-sectional view of a bicycle structure according to the present invention having a pair of openings or slits formed through a portion thereof;

FIG. 10 is a cross-sectional view of a bicycle structure according to the present invention having a passage or slit formed through a center portion thereof along a length of the bicycle structure and showing a slit along a width and diagonal slit thereacross in phantom;

FIG. 11 is a cross-sectional view of a bicycle structure according to the present invention having projections extending outwardly from sidewalls thereof; and

FIG. 12 is a cross-section view of a bicycle structure according to the present invention having depressions extending inwardly from sidewalls thereof.

### DETAILED DESCRIPTION OF THE PREFERRED EMBODIMENT

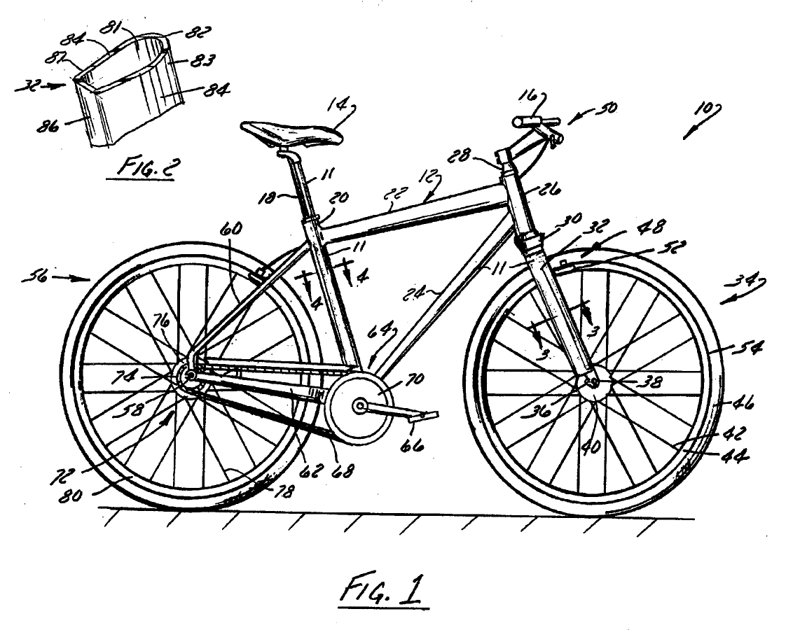

FIG. 1 shows a bicycle 10 having a number of bicycle structures 11 that are constructed according to the present invention. As described further below, it is envisioned that bicycle structures 11 be one or more of a bicycle frame tube, a fork blade, a wheel, a tire, a handlebar, a handle bar stem, a seat post, a pedal crank arm, a dropout, a shift lever, a cable guide, a cable, a bicycle accessory such as a water bottle, and a bicycle accessory holder constructed according to the present invention.

Bicycle 10 includes a frame 12 that supports a rider and forward and rearward wheel assemblies. Bicycle 10 includes a seat 14 and handlebars 16 that are attached to frame 12. A seat post 18 is connected to seat 14 and slidably engages a seat tube 20 of frame 12. A top tube 22 and a down tube 24 extend forwardly from seat tube 20 to a head tube 26 of frame 12. Handlebars 16 are connected to a stem 28 that passes through head tube 26 and engages a fork crown 30. A pair of forks 32 extend from generally opposite ends of fork crown 30 and are constructed to support a front wheel assembly 34 at an end or fork tip 36 of each fork 32. Fork tips 36 engage generally opposite sides of an axle 38 that is constructed to engage a hub 40 of front wheel assembly 34. A number of spokes 42 extend from hub 40 to a rim 44 of front wheel assembly 34. A tire 46 is engaged with rim 44 such that rotation of tire 46, relative to forks 32, rotates rim 44 and hub 40.

Bicycle 10 includes a front brake assembly 48 having an actuator 50 attached to handlebars 16 and a pair of brake pads 52 positioned on generally opposite sides of front wheel assembly 34. Brake pads 52 are constructed to engage a brake wall 54 of rim 44 thereby providing a stopping or slowing force to front wheel assembly 34. Alternatively, a disc brake assembly including a rotor and caliper may be positioned proximate hub 40 of front wheel assembly 34. Such assemblies are readily understood in the art. Understandably, one or both of front wheel assembly 34 and a rear wheel assembly 56 of bicycle 10 could be equipped with rim based or disc based braking systems.

Similar to front wheel assembly 34, rear wheel assembly 56 is positioned generally concentrically about a rear axle 58 such that rear wheel assembly 56 rotates about rear axle 58. A seat stay 60 and a chain stay 62 offset rear axle 58 from a crankset 64. Crankset 64 includes a pedal 66 that is operably connected to a chain 68 via a chain ring or sprocket 70. Rotation of chain 68 communicates a drive force to a rear section 72 of bicycle 10 having a gear cluster 74 positioned thereat. Gear cluster 74 is generally concentrically orientated with respect to rear axle 58 and includes a number of variable diameter gears. Understandably, sprocket 70 could also be provided with a number of variable diameter gears thereby enhancing the gearing ratios that can be attained with bicycle 10.

Gear cluster 74 is operationally connected to a hub 76 of rear wheel assembly 56. Rear wheel assembly 56 includes hub 76, a number of spokes 78, and a rim 80. Each of the number of spokes 78 extend between hub 76 and rim 80 and communicate the loading forces therebetween. As is commonly understood, rider operation of pedals 66 drives chain 68 thereby driving rear wheel assembly 56 which in turn propels bicycle 10. Front wheel assembly 34 and rear wheel assembly 56 are constructed such that spokes 42, 78 communicate the forces associated with the loading and operation of bicycle 10 between hubs 40, 76 and rims 44, 80, respectively. It is appreciated that bicycle 10 could form a mountain or off road bicycle or a road bike, or a bicycle configured for operation on paved terrain. Although more applicable to bicycles that commonly attain greater operating speeds, it is envisioned that a variety of bicycle configurations may benefit equally from the present invention.

Referring now to FIGS. 2-3, a cross-section through a bicycle structure 11, specifically one of forks 32, is shown. As shown in FIGS. 2 and 3, forks 32 have a cross-section 87 that forms only a forward portion of a traditional airfoil shape. Said in another way, cross-section 87 has a truncated airfoil shape. Forks 32 are generally tube-shaped and define a cavity 81 that is surrounded by a body 83 of the bicycle structure 11. The cross-section of body 83 has a leading edge, head, or head portion 82, a pair of opposed sidewalls 84 that extend rearwardly relative to head portion 82, and a rear wall or end wall 86. End wall 86 is generally opposite head portion 82. End wall 86, sidewalls 84, and head portion 82 are connected so as to surround cavity 81.

As described further hereafter, each of head portion 82, sidewalls 84, and end wall 86 may have shapes other than those shown. That is, head portion 82 may be generally curved and be provided in a variety of shapes between generally circular contours to more elliptical contours. Alternatively, head portion 82 may be shaped so as to have a more forward extending leading edge as can be provided with curved sections. Although sidewalls 84 are shown as having a generally smooth and continuous shape, as described below, it is envisioned that sidewalls 84 may have other shapes and/or discontinuities that alter the aerodynamic and/or physical performance of the body. Likewise, although end wall 86 is shown as having a generally planar shape that extends in an inward direction that is generally perpendicular to sidewalls 84, as described further below, it is envisioned that end wall 86 be provided in any of a number of shapes.

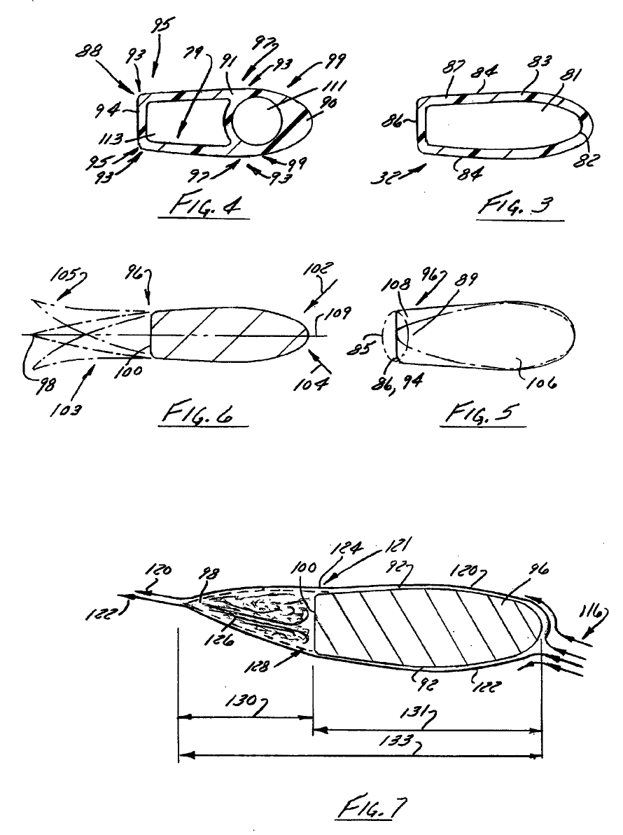

Preferably, body 83 is formed of moldable or curable materials such as carbon fiber materials. It is appreciated that the benefits of the present invention can be achieved independent of the material of the body 83. Body 83 could be formed of metal or other materials. It is further appreciated that, although cavity 81 is shown as being generally hollow, cavity 81 could be filled with a material, such as foam, and/or as described further below with respect to FIG. 4, have internal members that extend thereacross. It is further appreciated that body 83 could be solid and/or partially solid such that passages, vents, vent ports, ports, slits, and/or slots could be formed through body 83 so as alter the aerodynamic and/or physical performance of the body for desired characteristics.

As shown in FIGS. 3-6, in various embodiments, end wall 86 is generally flat, extends between sidewalls 84, and truncates the airfoil shape of body 83 relative to a traditional airfoil shape 106 (shown in phantom in FIG. 6). Referring back to FIG. 1, it should be appreciated that many of the structures of bicycle 10 are not maintained in a vertical plane. That is, a number of the structures of bicycle 10 cant forward or rearward relative to a vertical plane and with respect to a direction of travel or longitudinal axis of bicycle 10. For instance, forks 32 generally extend in a forward direction relative to head tube 26 and seat stays 60 extend in a rearward direction relative to seat tube 20. Each of these structures is maintained in a generally vertical orientation with respect to an operating orientation of bicycle 10.

For instance, forks 32 are shown positioned generally vertically, i.e., more vertical than horizontal. Forks 32 are further positioned at an angle with respect to a direction of airflow experienced by the bicycle 10 during riding. Referring back to FIG. 3, the truncated airfoil of forks 32 is positioned such that head portion 82 is positioned forward of end wall 86 with respect to a direction of airflow. The truncated airfoil shape of cross-section of body 83 of forks 32 as shown in FIGS. 2-3 is generally perpendicular to a longitudinal axis of forks 32. It is appreciated that truncated airfoil shaped cross section 87 elongates as the plane associated with the cross section is rotated so as to be aligned with the direction of travel of bicycle 10 rather than being oriented generally transverse to the longitudinal axis of forks 32.

FIG. 4 illustrates a cross-section through another specific bicycle structure 11, seat tube 20. It is appreciated that any of bicycle structures 11 could be provided with cross-sectional shapes that resemble either of sections shown in FIG. 3 or 4 and/or other cross-sectional shapes as described further below. Like cross-section of body 83 shown in FIG. 3, cross-section 91 shown in FIG. 4 may be any of a bicycle frame tube, fork blade, wheel, tire, handlebar, seat post, stem, pedal crank arm, dropout, shift lever and cable. Bicycle structure 88 has a head portion or head 90 that is preferably generally rounded, a pair of opposing sidewalls 92 that extend rearward from head 90, and a blunt rear wall or end wall 94. Each of cross-sections 87, 91 are formed in a generally continuous manner. That is, alternative ends 93 of end walls 86, 94 are joined to a rear facing end 95 of each sidewall 84, 92. A forward facing end 97 of each sidewall 84, 92 is joined to a respective end 99 of one of head portions 82, 90. As described above, it should be appreciated that ends 93, 95, 97, 99 of the respective portions of cross-sections 87, 91 are indicative of changes in direction rather than separable connections.

Although cross-section 91 has a generally hollow core or cavity 79 similar to cross-section of body 83, a partition 107 extends laterally across the width of the cross-section. Partition 107 extends across cavity 79 proximate head portion 90 thereby dividing cavity 79 into a forward cavity 111 and a rearward cavity 113. Similar to cross section 87, it is envisioned that each of cavities 111, 113 remain hollow or may be filled with an expandable material, such as foam or the like. Alternatively, bicycle structure 96 could be formed in a generally solid manner. Regardless of the interior structure of bicycle structure 96, cross-section 91 preferably has a length-to-width aspect ratio of between about 3:1 to about 9:1. Preferably, regardless of the specific location of bicycle structure 96, cross-section 91 has a length-to-width aspect ratio of about approximately 5:1.

Referring now to FIG. 5, bicycle structure 96 is shown with a standard airfoil shaped bicycle structure 106 having a similar aspect ratio shown in phantom thereover. The similar aspect ratio defines that both bicycle structure 96 and phantom structure 106 have similar maximum width and chord lengths. It is appreciated that bicycle structure 96 can be implemented into any number of bicycle structures where reduced aerodynamic drag and greater structural strength is desired. Although bicycle structure 96 has the same physical maximum length and width as the traditional airfoil shaped bicycle structure 106, bicycle structure 96 has improved aerodynamic performance compared to the traditional airfoil shaped bicycle structure 106 of a similar aspect ratio.

Still referring to FIG. 5, it is envisioned that end wall 84 be provided in any of a number of shapes 85, 89 (shown in phantom) rather than merely extending in a perpendicular direction related to the sidewalls of bicycle structure 106. As shown in FIG. 5, a number of different rear facing end wall 85, 86, 89 constructions are contemplated. In particular, end wall 86 is generally planar, end wall 85 is generally convex, and end wall 89 is generally concave. Simply, end wall 86, 94 can be provided in any of a variety of shapes without substantially detrimentally affecting the aerodynamic performance of structure 106.

Regardless of the position and orientation of the bicycle structure with respect to the overall bicycle assembly, as air flows over bicycle structure 96, a virtual airfoil tail 98 (FIG. 6) develops and extends rearward from the rear facing end wall 86, 94 of bicycle structure 96. Virtual airfoil tail 98 contributes to the aerodynamic performance of bicycle structure 96 in a manner that allows bicycle structure 96 to achieve better aerodynamic performance than phantom structure 106 (FIG. 5) although the structures have similar length-to-width aspect ratios. As used herein, the description of tail 98 as virtual merely indicates that lack of physical structure for forming the tail shape of the bicycle structures. As described further below, in some respects, virtual tail 98 contributes to the aerodynamic performance of the bicycle structure in a manner similar to a physical structure even though no physical structure forms virtual tail 98.

Bicycle structure 96 having a shortened tapered trailing edge, is more robust than traditional airfoil shaped bicycle structures 106 having the same aspect ratio, and has improved aerodynamic performance relative thereto. Truncating the aerodynamic fin or winged cross-sectional shape of bicycle structure 96 and allowing air to promulgate therebehind, is counterintuitive and contradicts the well accepted concept of gradually transitioning the aerodynamic shape formed by one or more structures from a leading edge to a diminishing point trailing edge.

Bicycle structures 96 according to the present invention realize improved aerodynamic performance, i.e., reduced drag, in-part because of the more gradual inward curvature of sidewalls 92. That is, as sidewalls 92 extend in a rearward direction from head portion 90, end wall 94 maintains sidewalls 92 at an orientation that is nearer to alignment with an axial length of the body than an airfoil shape having sidewalls of compared length that are joined to one another so as to maintain a desired aspect ratio. The more gradual inward curvature of sidewalls 92 in a rearward direction allows airflow passing over bicycle structure 96 to more closely adhere to sidewalls 92 thereby resulting in a point of separation of the airflow from sidewalls 92 that is nearer end wall 86, 94 as compared to traditional airfoil shapes 106 having the same aspect ratio. This more rearward point of separation results in a smaller turbulent wake with respect to bicycle structure 96 and less exposure of the bicycle structure to the turbulent flow thereby reducing overall drag on bicycle 10. That is, the later separation of the airflow reduces the aerodynamic losses as compared to an airfoil 106 having the same aspect ratio. Preferably, the length of the end wall is selected to cant the trailing edges of the sidewalls in an outward direction relative to an airfoil having a comparable aspect ratio such so that the point of separation occurs at a location that is as rearward as possible along the length of bicycle structure 96. Preferably, this point of separation is located approximately within the last ⅓-⅕ of the length of the bicycle structure 96 and rearward of the widest portion of bicycle structure 96.

Still referring to FIGS. 5 and 6, it can be readily understood that truncated tail portion 108 of bicycle structure 96 is wider and stiffer than the tail portion of the standard airfoil shaped structure 106. Thus, bicycle structure 96 is better adapted for the wear and tear or operational loading normally encountered by a respective bicycle. Accordingly, bicycle structure 96 also has improved physical performance expectations. Furthermore, omitting the vanishing point trailing edge from bicycle structure 96 improves the manufacturability of the bicycle structure 96 as compared to those bicycle structures provided with a traditional air foil cross-sectional shape.

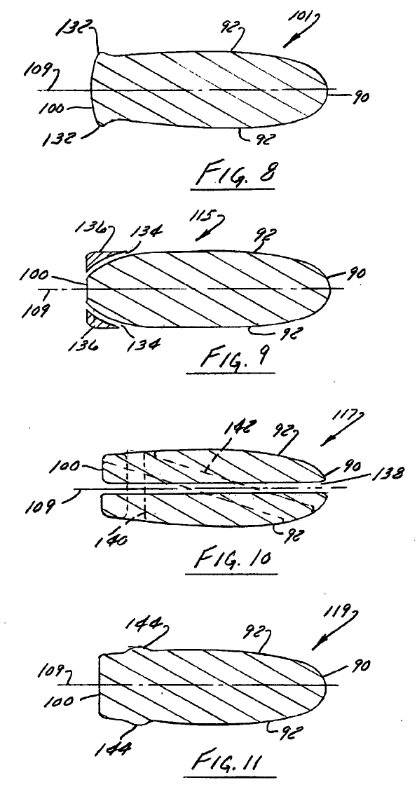

FIG. 6 shows the truncated airfoil shape of bicycle structure 96 and virtual airfoil tail 98 (shown in phantom) developed therebehind. During cycling, riders encounter aerodynamic drag created by the flow of air over the bicycle and the rider. The bicycle structure 96 according to the present invention is configured to reduce the amount of drag on the bicycle experienced by the rider. As an initial air flow flows around the truncated airfoil shape of bicycle structure 96, a recirculation zone develops at trailing or rear facing end wall 100 and forms virtual tail 98. As described further below with respect to FIG. 7, once virtual tail 98 is formed, a pseudo boundary layer forms about virtual tail 98 so that a majority of the subsequent airflow that separates from bicycle structure 96 proximate rear wall 100, is directed generally around the re-circulation zone so as to define the shape and size of virtual airfoil tail 98. That is, virtual tail 98 is formed by the relatively later separation of the air flow, represented by point of separation 121, from side walls 84, 92 of bicycle structure 96 so as to further contribute to the aerodynamic performance of bicycle structure 96.

Those skilled in the art will appreciate that, during use, the size, shape, and orientation of virtual tail 98 relative to bicycle structure 96 will change as a function of at least the flow, velocity, and angle of attack or yaw of the air flow directed thereover. It is further appreciated that, although bicycle structure 96 is shown as having a cross-sectional shape that is generally symmetrical relative to the longitudinal axis of the cross-section, bicycle structure 96 could have an asymmetric shape for those instances where it is desirable to provide a virtual tail having a lateral component unassociated with the angle of attack of the air flow. That is, it is envisioned that bicycle structure 96 be shaped to cooperate with the overall structure of bicycle 10 so as to provide a desired aerodynamic performance in a lateral direction relative to a longitudinal axis of the bicycle.

Referring to FIGS. 6 and 7, as virtual airfoil tail 98 is created by the air flowing off of bicycle structure 96, the virtual airfoil tail 98 is flexible and capable of bending with the direction of the wind, i.e., yaw angle, thereby improving aerodynamic performance and reducing drag. It is further appreciated that drag performance increases as the yaw angle or angle of attack of the air flow increases up until drag stall occurs. It is further appreciated that drag stall occurs at higher yaw angles as compared to bicycle structures having a fully developed airfoil shape.

As shown in FIG. 6, the virtual airfoil tail 98 is shown in various alternate shapes that form in response to changing wind directions, i.e. angles of attack or yaw angles. When the air flow has an angle of attack that approaches bicycle structure 96 in a left to right lateral direction, represented by arrow 102, virtual tail 98 attains a right side shape or position 103 rearward of rear wall 100. The virtual tail 98 associated with right side shape 103 tapers in a rightward lateral direction away from a longitudinal center axis 109 of bicycle structure 96. Similarly, when the air flow attacks bicycle structure 96 in a right to left direction, represented by arrow 104, virtual tail 98 attains a left side shape or position 105 rearward of rear wall 100. When in left side position 105, virtual tail 98 forms rearward of rear wall 100 and tapers in a leftward lateral direction relative to axis 109. Accordingly, virtual airfoil tail 98 deflects in compliance to the aerodynamic conditions subjected to bicycle structure 96. Simply, unlike bicycle structures with fully developed airfoil shapes, the size, shape, and orientation of virtual air tail 98 is responsive to changes in the airflow over bicycle structure 96.

FIG. 7 shows a graphical representation of the aerodynamic performance of bicycle structure 96 when subjected to an exemplary air flow, wherein bicycle structure 96 has an actual length represented by arrow 131 and a virtual airfoil length represented by arrow 133. Air flow 116 represents an air flow that attacks bicycle structure 96 at approximately 10 degrees from the longitudinal axis 109 of the bicycle structure 96. This is commonly understood as the angle of attack, attack angle, or yaw angle of the fluid flow. As shown in FIG. 7, upon impact with bicycle structure 96, air flow 116 imparts a number of variable directional flows as air flow 116 separates into respective flows 120, 122 directed around the opposite sides of bicycle structure 96.

As air flows 120, 122 pass over sidewalls 92 of the bicycle structure a boundary layer 124 forms along the surface of each respective sidewall 92. As the air flows approach rear wall 100 of bicycle structure 96, a recirculation zone 126 forms rearward of rear wall 100. Virtual tail 98 is formed by air that remains in recirculation zone 126. As the fluid dynamics of recirculation zone 126 and boundary layer 124 approach each other, boundary layer 124 generates a pseudo boundary layer 128 that generally overlies recirculation zone 126. Pseudo boundary layer 128 is only termed a pseudo layer because there is no rigid structure that supports the boundary layer. Pseudo boundary layer 128 is formed rearward of bicycle structure 96 and is only supported by recirculation zone 126.

The fluidity of boundary layer 124 and pseudo boundary layer 128 aerodynamically substantially isolate recirculation zone 126 from the air flows 120, 122 over bicycle structure 96 after the propagation of recirculation zone 126. Such a configuration allows the respective air flows 120, 122 to remain in a more aerodynamically efficient interaction with bicycle structure 96 as compared to a standard airfoil shape structure having a length and width comparable to bicycle structure 96. The relative continuity of boundary layer 124 and pseudo boundary layer 128 minimizes the detrimental aerodynamic affects associated with air flow separation near the edges of rear facing end wall 100 of bicycle structure 96.

Air flows 120, 122 rejoin one another rearward of recirculation zone 126. As airflows 120, 122 flow over recirculation zone 126 recirculation zone 126 accommodates the lateral component associated with airflow 116 so as counteract a substantial portion, if not all, of the differential lateral loading of bicycle structure 96 due to the non-longitudinally aligned attack angle associated with air flow 116. As explained above with respect to FIG. 6, the size, shape, and orientation of virtual tail 98 relative to bicycle structure 96 varies in response to the aerodynamic performance of bicycle structure 96 as well as to changes in the environmental airflow conditions.

To ensure desired aerodynamic performance of bicycle structure 96, bicycle structure 96 is maintained at a desired offset distance 130 from any and all rearwardly adjacent portions or structures of bicycle 10. That is, end wall 100 of the bicycle structure 96 is preferably positioned such that there is a minimum distance between the end wall of the bicycle structure 96 and an adjacent portion of bicycle 10. Offset distance 130 is preferably sufficient to allow full development of recirculation zone 126 without aerodynamic interference from other structures of bicycle 10.

It is appreciated that a variety of different values of offset distance 130 can be provided by altering the cross-sectional shape of bicycle structure 96. For instance, tapering sidewalls 92 inward proximate rear wall 100 would reduce the offset distance 130 associated with full fluid development of recirculation zone 126 although such a modification would adversely affect the point of air flow separation 121. It is further appreciated that offset distance 130 is determined in part by the variable parameters associated with air flow 116. Preferably, offset 130 is determined by the cross-section of bicycle structure 96, the location of bicycle structure 96 relative to a bicycle 10, and the prevailing air flow conditions 116 associated with an environment of operation of bicycle 10. It is appreciated that bicycles configured for different uses and operated in different environments and/or geographic areas may have dissimilar preferred offset distances 130.

By way of example, if down tube 24 is formed in the truncated air foil shape, adjacent longitudinal structures are maintained at desired offset distances 130. That is, down tube 24 is preferably maintained at a distance far enough away from adjacent structures such as the seat tube 64 and/or other bicycle structures to allow virtual airfoil tail 98 to fully develop therebetween.

Alternatively, the bicycle structure 96 may be configured to cooperate with another structure of the bicycle 10 to form the truncated tail shape according to the present invention or to form a complete airfoil shape. By way of example, if seat tube 20 comprises a forward portion of a truncated airfoil shape in accordance with the present invention, seat tube 20 is preferably positioned at a distance near enough the rear wheel assembly 56 and/or other bicycle structures to fully form either a truncated airfoil shape or a complete airfoil shape when in combination therewith. It is further envisioned that accessories, such as water bottles, storage cases or like, intended to interact with bicycle 10, also have one of a truncated airfoil shape and/or complete the airfoil shape of the bicycle structure. Those accessories and/or accessory mounting systems that have a truncated airfoil shape are envisioned as having forward facing sides that cooperate with the rearward facing side of the bicycle structure and a rearward facing side shaped so that the combined bicycle structure and accessory have a generally continuous, truncated airfoil shaped, cross-section shape.

Turning now to FIGS. 8-11, alternative constructions of bicycles structures according to the present invention are shown. Referring initially to FIG. 8, an alternative bicycle structure 101 includes a head portion 90 and rearwardly extending side walls 92. The sidewalls 92 and end wall 86, 94 cooperate to form a pair of outwardly extending projections 132 that extend rearward and outward from sidewalls 92. Bicycle structure 101 shown in FIG. 8 has a forward positioned point of flow separation but has improved structural lateral performance as compared to the bicycle structure shown in FIG. 7.

FIG. 9 illustrates yet another alternative bicycle structure 115 according to the present invention. Bicycle structure 115 of this embodiment includes a pair of openings, ports, passages, slots, or slits 134 that are formed proximate the interface of sidewalls 92 and end wall 100 through structure 115. Slits 134 allow a portion of the air flow over structure 115 to pass within a footprint of the cross-section of the body and alter the propagation of the recirculation zone. Structure 115 shown in FIG. 9 also experiences improved aerodynamic performance over traditional airfoils having a similar aspect ratio. Slits 134 allow air to pass therethrough during riding so as to further populate recirculation zone 126 (See FIG. 7) behind end wall 86, 94 thereby assisting in the creation of the virtual tail 98 in the wake of bicycle structure 115.

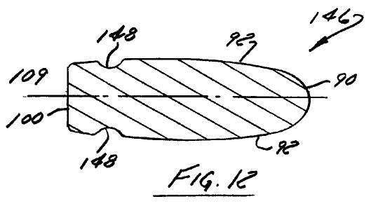

FIG. 10 illustrates another alternative bicycle structure 117 of the present invention. Similar to the bicycle structure 115 shown in FIG. 9, bicycle structure 117 of the present embodiment may include one or more passages, slits, slots, or ports that are formed across structure 117 in a variety of orientations. As shown in FIG. 10, one or more slits 138 may be provided along a longitudinal length of the bicycle structure 117 through the center of bicycle structure 117 and running along a length of the cross section thereof. Slit 138 allows air flow experienced by bicycle structure 117 to flow through the structure 117 and populate the recirculation zone 126 behind end wall 86, 94 as mentioned previously.

Bicycle structure 117 may also include one or more opens, slots, passages, or slits 140 that extending across a width of cross section of bicycle structure 117. Further, bicycle structure 117 may include one or more slits 142 positioned diagonally across the length and width of the cross section of bicycle structure 117. As with slits 138 and 140, slit 142 is configured to allow air to pass therethrough to populate recirculation zone 126 with airflow that populates virtual tail 98. It is understood that bicycle structure 117 may be configured such that slits 138, 140, 142 may be positioned at different points along a length of bicycle structure 11. It is further appreciated that the spacing of slits 138, 140, 142 may vary as a function of the use, orientation, and position of the respective bicycle structures. Alternatively, it is understood that the slits 138, 140, 142 may be positioned to accommodate the physical orientation of bicycle structure 117 to provide bicycle 10 with improved aerodynamic performance by directing the airflow through slits 138, 140, 142.

FIG. 11 illustrates another bicycle structure 119 according to the present invention. Each of sidewalls 92 may include one or more projections 144 that extend outwardly therefrom. Projections 144 may be positioned at any number of points along a length of bicycle structure 119. Further, projections 144 may comprise a number of different shapes. That is, the projections may comprise generally rounded “bumps” or may be generally pointed. It will be appreciated by those skilled in the art that the aerodynamic discontinuity associated with projections 144 is generally shape independent. A number of alternative projection shapes, sizes, and orientations relative to structure 119 may be used. Projections 144 may be positioned at any number of points along a length of bicycle structure 119. Preferably, projections 144 are symmetric with respect to each of sidewalls 92. The projections 144 are positioned and configured to prevent separation of airflow from sidewalls 92 such that a smaller turbulent wake is produced rearward of bicycle structure 119 to thereby reduce the drag experienced by bicycle 10. Further, projections 144 are positioned to assist in populating recirculation zone 126 to help form virtual tail 98.

FIG. 12 illustrates yet another bicycle structure 146 according to the present invention. Each of sidewalls 92 may include one or more depressions 148 that extend inwardly therefrom. Depressions 148 may be positioned at any number of points along a length of bicycle structure 146. Depressions 148 may comprise a number of different shapes such as generally rounded or pointed. It will be appreciated by those skilled in the art that the aerodynamic discontinuity associated with depressions 148 is generally shape independent. A number of alternative depression sizes, shapes and orientations relative to structure 1467 may be utilized in accordance with the present invention. Preferably, depressions 148 are symmetric with respect to each of sidewalls 92. The depressions 148 are positioned and configured to prevent airflow from separating from sidewalls 92 such that a smaller turbulent wake is produced rearward bicycle structure 146 to thereby reduce the drag experienced by bicycle 10. In addition, depressions 148 are positioned to assist in populating recirculation zone 126 to help form virtual tail 98.

The present invention has been described in terms of the preferred embodiment, and it is recognized that equivalents, alternatives, and modifications, aside from those expressly stated, are possible and within the scope of the appending claims. It is further appreciated that the respective features of any one of the embodiments discussed above is not necessarily solely exclusive thereto.

What is claimed is:

1. A bicycle structure comprising:
a body defined by an exterior wall oriented to have a cross-sectional shape that resembles a forward portion of an airfoil shape;
wherein the cross-sectional shape is defined by a head portion, a pair of opposing sidewalls that extend rearward from generally opposite ends of the rounded head portion, and an end wall that is offset from the rounded head portion and that extends in a crossing direction relative to each sidewall so as to join rearward directed ends of each of the pair of opposing sidewalls; and
wherein the body is attached to a bicycle so as to maintain an open space rearward of the body such that a tail portion of the airfoil shape is formed by air that occupies the open space rearward of the end wall.

2. The bicycle structure of claim 1, wherein the head portion is rounded.

3. The bicycle structure of claim 1, wherein the sidewalls of the cross-sectional shape include a projection extending outwardly therefrom.

4. The bicycle structure of claim 1, further comprising at least one of a slot and a passage formed through the body.

5. The bicycle structure of claim 1, wherein the cross-sectional shape is asymmetrical about a longitudinal axis thereof.

6. The bicycle structure of claim 1, wherein the tail portion of the airfoil shape changes shape due to changes in an airflow over the body.

7. The bicycle structure of claim 1, wherein the bicycle structure is further defined as at least one of a bicycle frame tube, a fork blade, a wheel, a tire, a handlebar, a seat post, a handlebar stem, a crank arm, a dropout, a shift lever, or a cable.

8. The bicycle structure of claim 1, wherein the cross-sectional shape of the body has a length-to-width aspect ratio of between about 3:1 and about 9:1.

9. The bicycle structure of claim 8, wherein the length-to-width aspect ratio is approximately 5:1.

10. The bicycle structure of claim 1 wherein a longer dimension of the cross-sectional shape is generally aligned with a longitudinal axis of the bicycle and oriented in a plane that is generally parallel to an operating surface traversed by the bicycle.

11. The bicycle structure of claim 1, wherein the bicycle structure is shaped to accommodate a bicycling accessory whose cross sectional shape one of generally resembles the cross sectional shape of the bicycle structure or cooperates with the cross sectional shape of the bicycle structure to complete an airfoil shape.

12. The bicycle structure of claim 11, wherein the bicycle accessory is at least one of a water bottle and a storage case.

13. A bicycle comprising:
a frame;
a seat supported on the frame and configured to support a rider;
a pair of wheels rotatably attached to the frame;
a bicycle structure having a partially airfoil shaped cross-section, the cross-section having a head portion, a pair of opposing sidewalls that extend rearward relative to the head portion, and a rear wall generally opposite the head portion; and
wherein the bicycle structure is maintained at an offset distance relative to adjacent structures of the bicycle, the offset distance being sufficient to allow air that travels over the bicycle structure to form a virtual airfoil tail rearward of the rear wall of the bicycle structure.

14. The bicycle of claim 13 wherein a value of the offset distance is selected so that the virtual air foil tail is approximately triangularly shaped and forms at a variety of operating speeds of the bicycle.

15. The bicycle of claim 13, wherein the bicycle structure is at least one of a tube of the frame, a fork blade, a wheel, a tire, a handlebar, a seat post, a stem, a seat post, a crank arm, a dropout, a shift lever, a cable guide, and a cable.

16. The bicycle of claim 13, wherein the partially airfoil shaped cross-section has a length-to-width ratio between about 3:1 and about 9:1.

17. The bicycle of claim 16, wherein the length-to-width ratio is approximately 5:1.

18. The bicycle of claim 16, wherein a length of the length-to-width ratio of the partially airfoil shaped cross-section of the bicycle structure is generally aligned with a longitudinal axis of the bicycle structure.

19. The bicycle of claim 13, further comprising a bicycle accessory that has a cross-section that mimics the partially airfoil shaped cross-section of the bicycle structure and has an aerodynamically unobstructed rear wall.

20. A method for providing an aerodynamic bicycle structure comprising:
providing a body having a truncated airfoil shaped cross-section; and maintaining a rear facing side of the body in a spaced relation relative to adjacent structures such that air directed over the body forms a virtual airfoil tail that tapers from the rear facing side of the body to a trailing edge as air flows around the bicycle structure.

21. The method claim 20, further comprising maintaining a lateral offset between the rear facing side of the body and adjacent structures so that the virtual airfoil tail can turn in response to changes in an angle of attack of an air flow.

22. The method of claim 20, further comprising forming the truncated airfoil shaped cross-section with a length-to-width ratio of between about 3:1 and about 9:1.

23. The method of claim 20, further comprising forming the truncated airfoil shaped cross-section with a length-to-width ratio of about 5:1.

24. The method of claim 20, further comprising providing a bicycle accessory that cooperates with the shape of the truncated airfoil shaped cross-section and has a blunt rear facing side so as to form a virtual airfoil tail rearward of the bicycle accessory.

25. The method of claim 24 such that the combination of the bicycle accessory and the truncated airfoil shaped cross-section results in an overall length-to-width ratio greater than 9:1.
